(19) United States
(12) Patent Application Publication
(10) Pub. No.: US 2006/0200600 A1
(43) Pub. Date: Sep. 7, 2006

(54) OPTICAL BUS EXTENSION DEVICE

(75) Inventor: Joseph Groso, Carson City, NV (US)

Correspondence Address: IAN F. BURNS & ASSOCIATES, P.O. BOX 71115, RENO, NV, 89570, US

(73) Assignee: CUBIX CORPORATION, Carson City, NV (US)

(21) Appl. No.: 11/306,842

(22) Filed: Jan. 12, 2006

Related U.S. Application Data
(60) Provisional application No. 60/643,185, filed on Jan. 12, 2005.

(51) Int. Cl. G06F 13/38

(52) U.S. Cl. 710/62

(57) ABSTRACT

The present invention comprises a computer communication device that includes an interface circuit mounted with a computer. The interface circuit is connected between a computer bus and fiber optic transceiver. Another interface circuit is mounted remotely from the computer. The other interface circuit is connected between a peripheral device bus and another fiber optic transceiver. Both fiber optic transceivers can be connected to opposite ends of a fiber optic cable. The computer communication device allows a peripheral device to be located remote from the computer.

### CROSS REFERENCE TO RELATED APPLICATIONS

This application claims priority to U.S. provisional patent application Ser. No. 60/643,185, filed Jan. 12, 2005 and entitled, “Optical Bus Extension,” the contents of which are herein incorporated by reference.

### BACKGROUND

1. Field of the Invention

The present invention relates to a computer communication device that is used to interface a host computer to remote peripheral devices. In particular, the invention relates to a device that connects remote peripheral devices on a PCI bus through a fiber optic connection to a host computer PCI express bus.

2. Description of the Related Art

Personal computers are in widespread use through out offices, schools and corporations. An individual personal computer is typically located at each user location. Each computer is typically linked to a network by a communication device such as an Ethernet card and category 5 cabling.

Unfortunately, in networks of personal computers, computer maintenance, data backup and security are difficult to implement. Individual computers distributed throughout a building can be subject to theft and vandalism. With each computer widely spaced, repairs by a technician can be difficult and time consuming. In a factory location, personal computers may be located in a harsh or dirty environment that may cause the computers to fail.

Another problem associated with traditional computers is data security due to radiated electromagnetic emissions. Since, data is being transmitted over electrical cables, the cables are subject to emitting electromagnetic fields that can be intercepted by electronic eavesdropping.

Personal computers contain data and address buses. Computer buses are well known communication links that are used to connect multiple computer subsystems. For example, a computer bus is used to link the memory and processor, and to link the processor with input/output (I/O) or peripheral devices.

Various types of computer buses are known. Some busses are specifically designed for use with specific computer communications. For example, processor to memory buses typcially are short, generally high speed, and matched to the memory system so as to maximize the memory to processor bandwidth.

Input output buses typically have many types of devices connected to them, and often have a wide range in the data bandwidth of the connected devices. Input output buses are frequently standard buses with parameters established by industry standards. Examples of industry standard buses are the PCI bus and the PCI express bus.

The PCI bus is a parallel bus that is used to communicate within a computer between peripheral devices and a processor. The PCI express bus was developed as a faster high speed bus. The PCI express bus is a serial bus that carries data in packets along two pairs of point to point data lines.

A current need exists for a computer network communication device that can provide a user access to a computer that has improved physical security and data security, easier computer maintenance, a climate controlled environment and redundant data backup. Such a communication device would allow a processor and storage devices to be stored and maintained at a central facility that is remote from peripheral devices that are at the user location.

### SUMMARY

Advantages of One or More Embodiments of the Present Invention

The various embodiments of the present invention may, but do not necessarily, achieve one or more of the following advantages:

provide a computer system in which the computer can be mounted in a secure area;

provide a keyboard and monitor that can be remotely located from the host computer;

provide a computer network that has a host computer located in a central location and remotely accessed peripheral devices located in another area;

covert an electrical signal to an optical signal;

communicate between two circuits using fiber optic cable;

provide a bus expansion device that allows for additional peripheral devices to be connected with a computer;

provide a conversion device that can convert a serial bus signal to a parallel bus signal;

expand a PCI bus;

interface a serial PCI express bus to a parallel PCI bus;

provide an optical communication network link between a computer and one or more peripheral devices; and

provide a secure communication network that does not leave an electromagnetic signature.

These and other advantages may be realized by reference to the remaining portions of the specification, claims, and abstract.

### BRIEF DESCRIPTION

The present invention comprises a computer communication device that includes a first interface circuit mounted in association with a host computer. The first interface circuit is connected between a host computer bus and a first fiber optic transceiver. The first fiber optic transceiver can be connected with a fiber optic cable. A second interface circuit is mounted remotely from the host computer. The second interface circuit is connected between a peripheral device bus and a second fiber optic transceiver. The second fiber optic transceiver can be connected with the fiber optic cable. The computer communication device allows a peripheral device to be located remote from the host computer.

The present invention further comprises a method of communicating between a peripheral device and a computer. The method includes transmitting a first electrical signal from the computer to a first interface circuit. The first electrical signal is converted to an optical signal. The optical signal is transmitted from the first interface circuit to a second interface circuit. The optical signal is converted to a second electrical signal. The second electrical signal is transmitted to the peripheral device.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary.

There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The embodiments of the present invention are shown in the drawings, wherein:

FIG. 1 is substantially a diagrammatic view of an embodiment of a computer system in accordance with the present invention.

FIG. 2 is substantially a diagrammatic view of an embodiment of a communication device using an optical fiber in accordance with the present invention.

FIG. 3 is substantially a diagrammatic view of the processor and interface circuits of FIG. 2.

FIG. 4 is substantially a partial schematic view of a PCI express bus to fiber optic interface circuit.

FIG. 5 is substantially another partial schematic view of a PCI express bus to fiber optic interface circuit.

FIG. 6 is substantially an additional partial schematic view of a PCI express bus to fiber optic interface circuit.

FIG. 7 is substantially a portion of a schematic view of a fiber optic to PCI bus interface circuit.

FIG. 8 is substantially another portion of a schematic view of a fiber optic to PCI bus interface circuit.

FIG. 9 is substantially another portion of a schematic view of a fiber optic to PCI bus interface circuit.

FIG. 10 is substantially another portion of a schematic view of a fiber optic to PCI bus interface circuit.

FIG. 11 is substantially another portion of a schematic view of a fiber optic to PCI bus interface circuit.

FIG. 12 is substantially another portion of a schematic view of a fiber optic to PCI bus interface circuit.

FIG. 13 is substantially another portion of a schematic view of a fiber optic to PCI bus interface circuit.

FIG. 14 is substantially another portion of a schematic view of a fiber optic to PCI bus interface circuit.

FIG. 15 is substantially another portion of a schematic view of a fiber optic to PCI bus interface circuit.

FIG. 16 is substantially another portion of a schematic view of a fiber optic to PCI bus interface circuit.

FIG. 17 is substantially another portion of a schematic view of a fiber optic to PCI bus interface circuit.

FIG. 18 is substantially a timing diagram of the communication system during power up.

FIG. 19 is substantially a timing diagram of the communication system during power down.

FIG. 20 is substantially a timing diagram of the communication system during shutdown.

FIG. 21 is substantially a timing diagram of the communication system during reset.

FIG. 22 is substantially a diagrammatic view of another embodiment of a communication device in accordance with the present invention.

FIG. 23 is substantially a portion of a schematic view of a PCI bus to fiber optic interface circuit.

FIG. 24 is substantially another portion of a schematic view of a PCI bus to fiber optic interface circuit.

FIG. 25 is substantially another portion of a schematic view of a PCI bus to fiber optic interface circuit.

FIG. 26 is substantially another portion of a schematic view of a PCI bus to fiber optic interface circuit.

FIG. 27 is substantially another portion of a schematic view of a PCI bus to fiber optic interface circuit.

FIG. 28 is substantially another portion of a schematic view of a PCI bus to fiber optic interface circuit.

FIG. 29 is substantially another portion of a schematic view of a PCI bus to fiber optic interface circuit.

FIG. 30 is substantially a block diagram of an embodiment of a method of communicating data using the present invention.

FIG. 31 is substantially a block diagram of another embodiment of a method of communicating data using the present invention.

### DESCRIPTION OF THE EMBODIMENTS

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Computer System

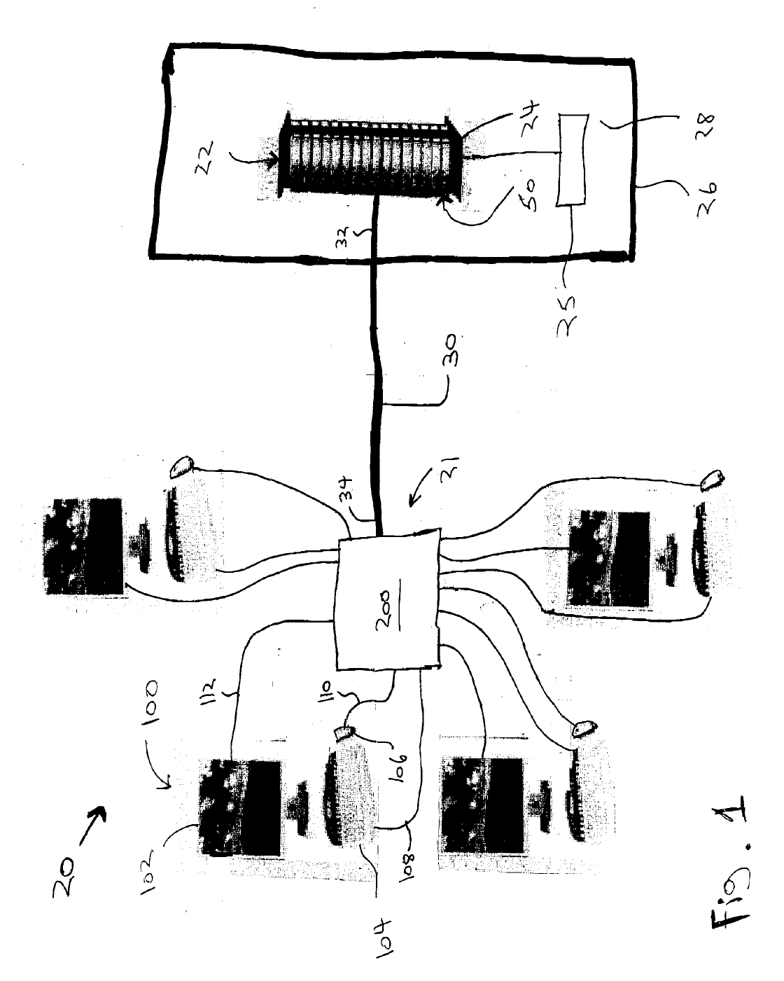

The present invention comprises a computer system or assembly, generally indicated by reference number 20. Referring to FIG. 1, computer system 20 can include a communication device 21 that provides communications between a host computer 50 and one or more peripheral devices 100. A group or network 22 of host computers 50 are mounted in a rack 24. Rack 24 can be conventional computer rack and include a housing, power cables, and cooling fans. Computers 50 can be conventional personal computers that are based upon microprocessor architecture and include storage devices and an operating system. Computers 50 can also be blade type computers that are plugged into a backplane.

Rack 24 and computers 50 are located in a secure enclosed area 26. Secure enclosed area 26 can be a data center that has restricted access only to authorized personnel. Secure enclosed area 26 can contain a climate controlled environment 28. Enclosed area 26 would contain air and humidity handling devices in order to maintain a stable atmosphere within area 26.

A backup data storage system 25 can be connected with the computers of network 22 in order to provide redundant data storage and a more fault tolerant system.

A fiber optic cable 30 may be connected between host computer 50 and a remote interface box 200. Fiber optic cable 30 is a conventional fiber optic cable that is commercially available from Optical Fiber Corporation. Fiber optic cable 30 has ends 32 and 34. Fiber optic cable is a two part cable that includes a transmission cable and a receive cable. End 32 is connected with computer 50 and end 34 is connected with remote interface box 200. Fiber optic cable 30 provides an optical communication path between computer 50 and remote interface box 200. Remote interface box 200 can be located at some distance from secure area 26. In one embodiment, remote interface box 200 can be located up to 250 meters from secure area 26. Remote interface box 200 may also be located longer or shorter distances from secure area 26.

A wide variety of peripheral devices 100 can be connected to remote interface box 200. Peripheral devices 100 can include a video monitor 102, monitor connector 112, keyboard 104, keyboard connector 108, a mouse 110, and a mouse connector 110. Peripheral device 100 can also be many other devices that are not shown such as data storage drives, cameras, printers and speakers.

It is noted that one or more than one peripheral device can be connected with remote interface box 200. In the embodiment shown in FIG. 1, four monitors, keyboards and mice are shown connected to host computer 50 through communication device 21. Communication device 21 includes remote interface box 200 and fiber optic cable 30.

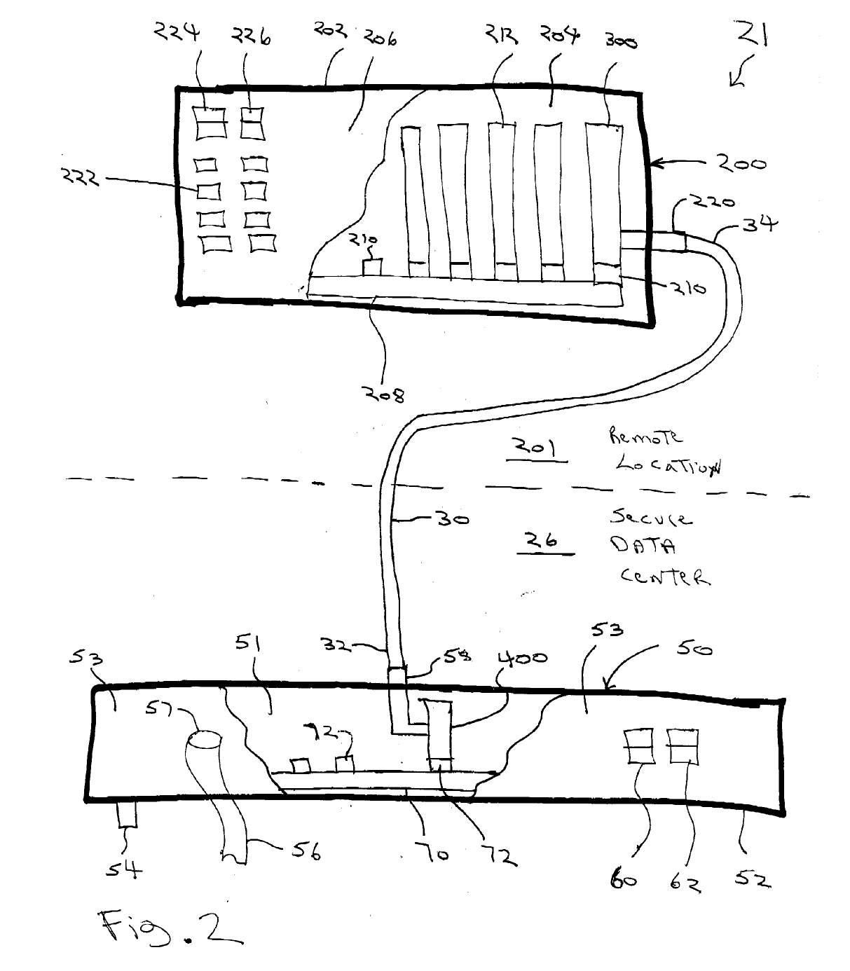

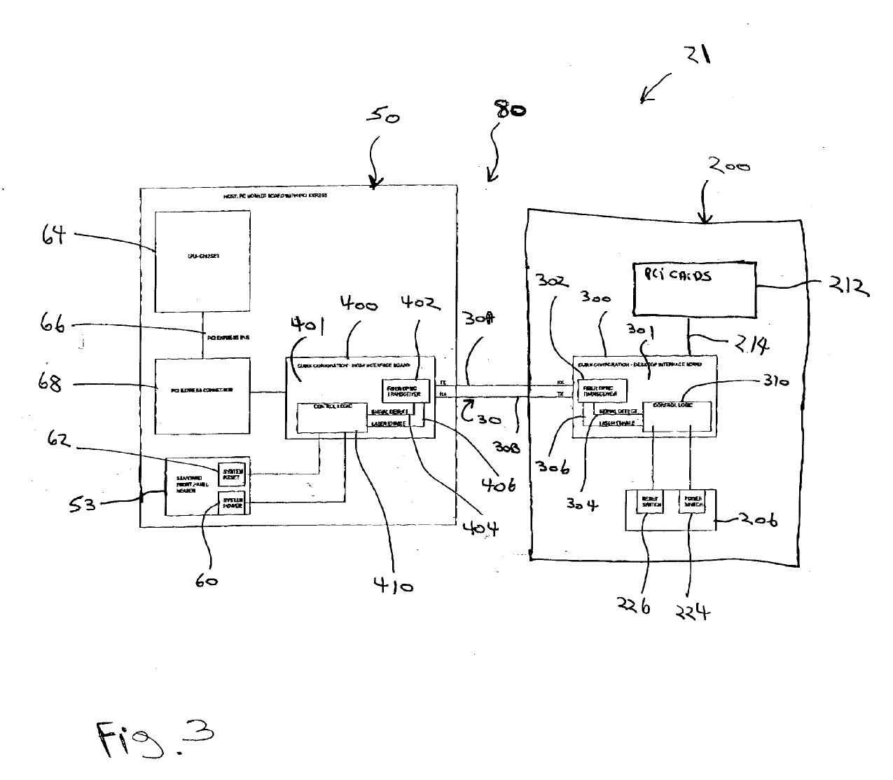

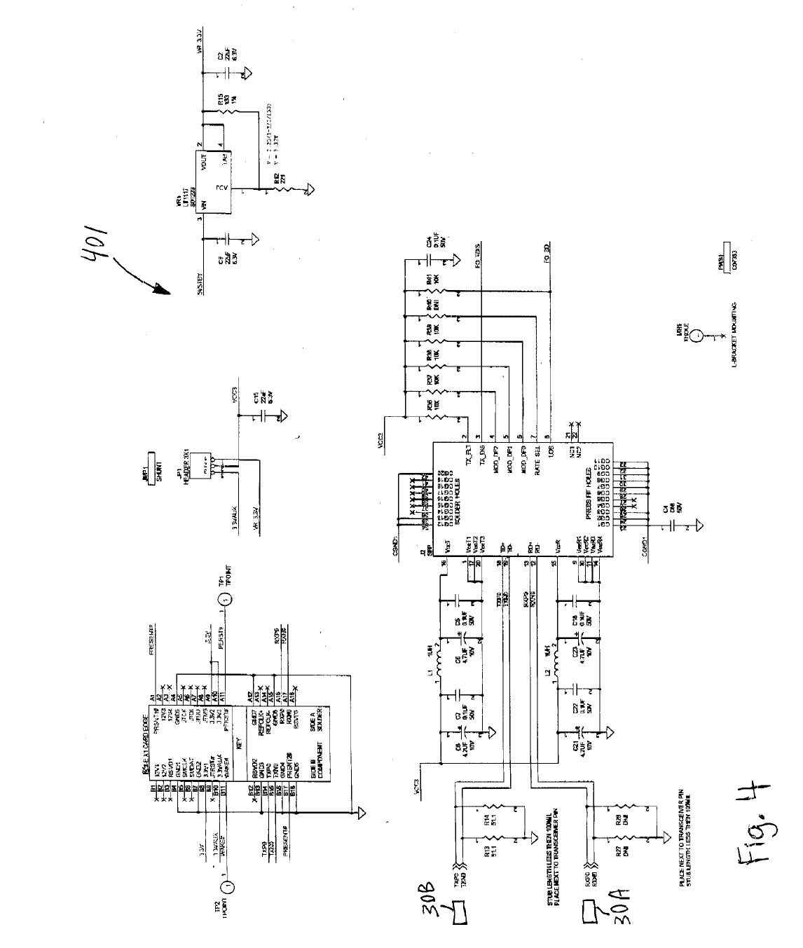

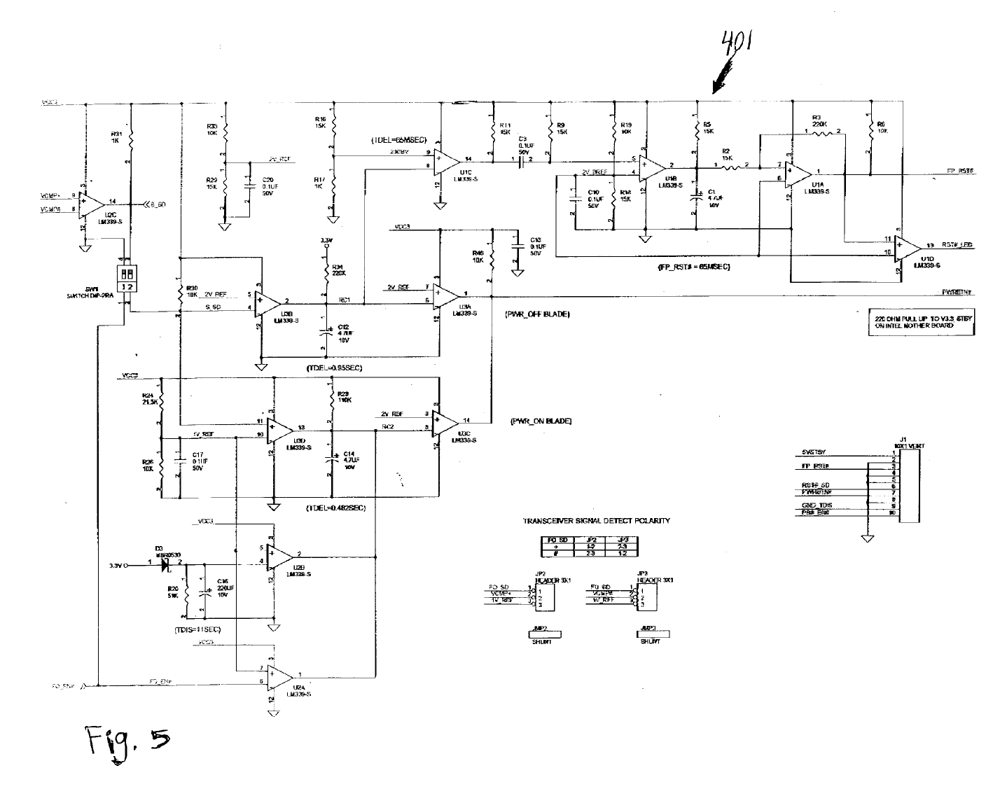

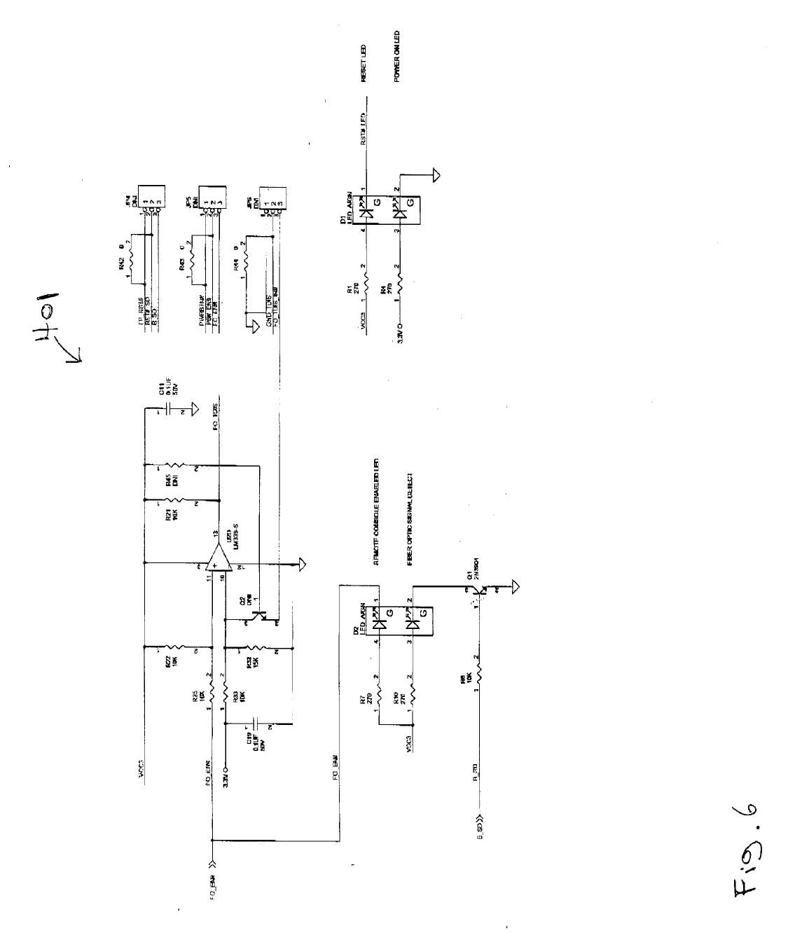

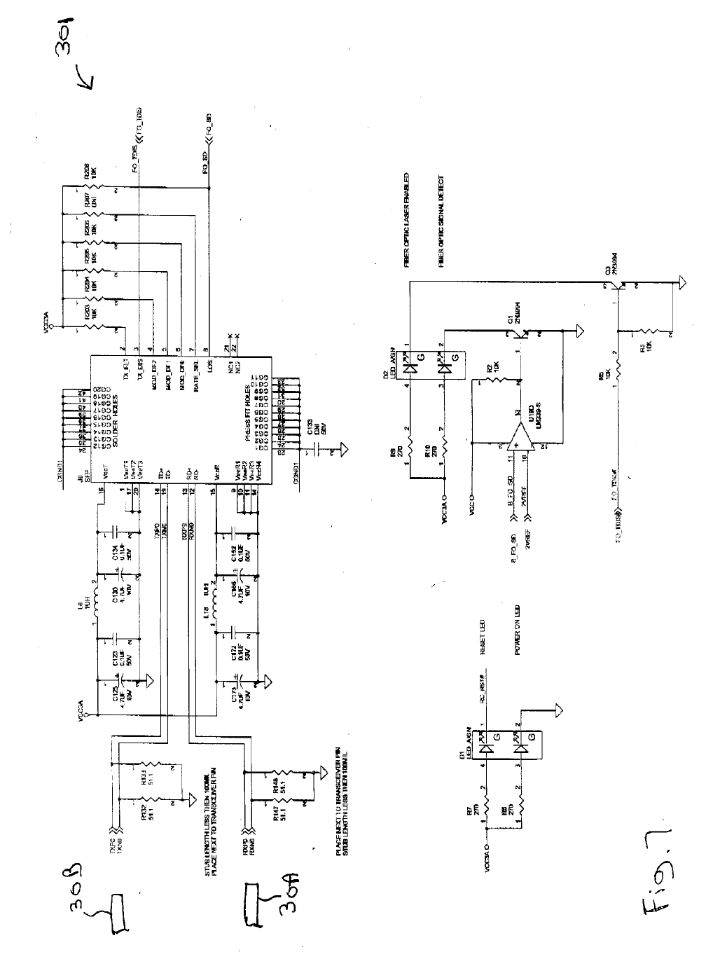

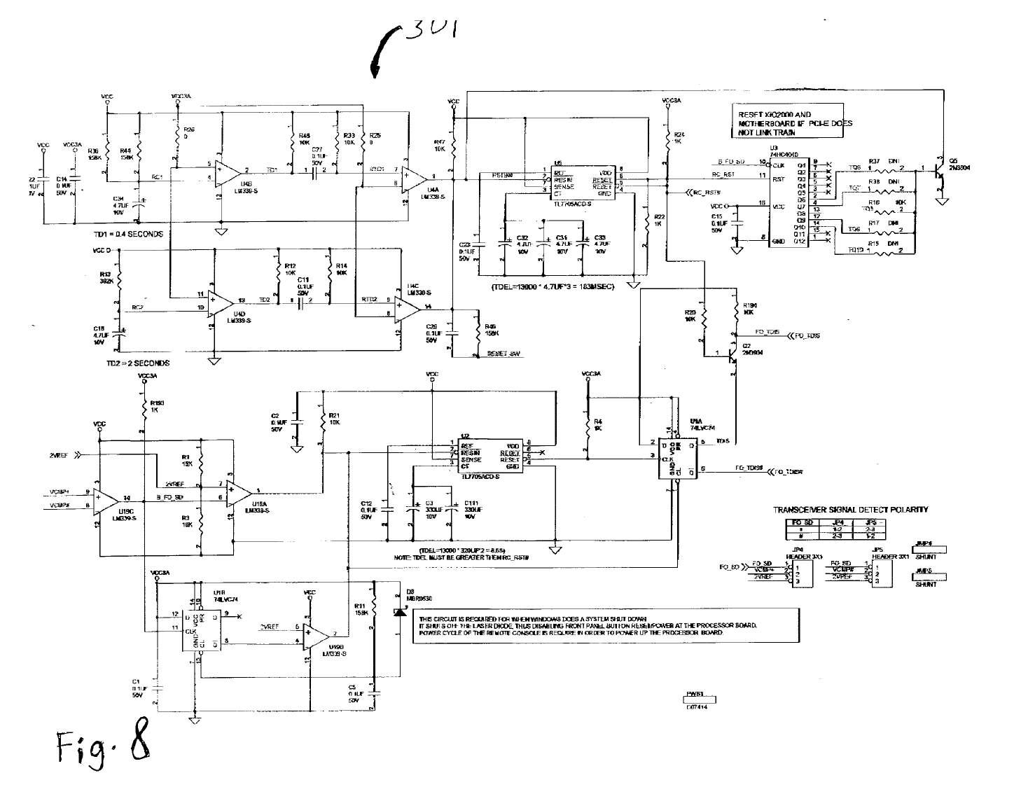

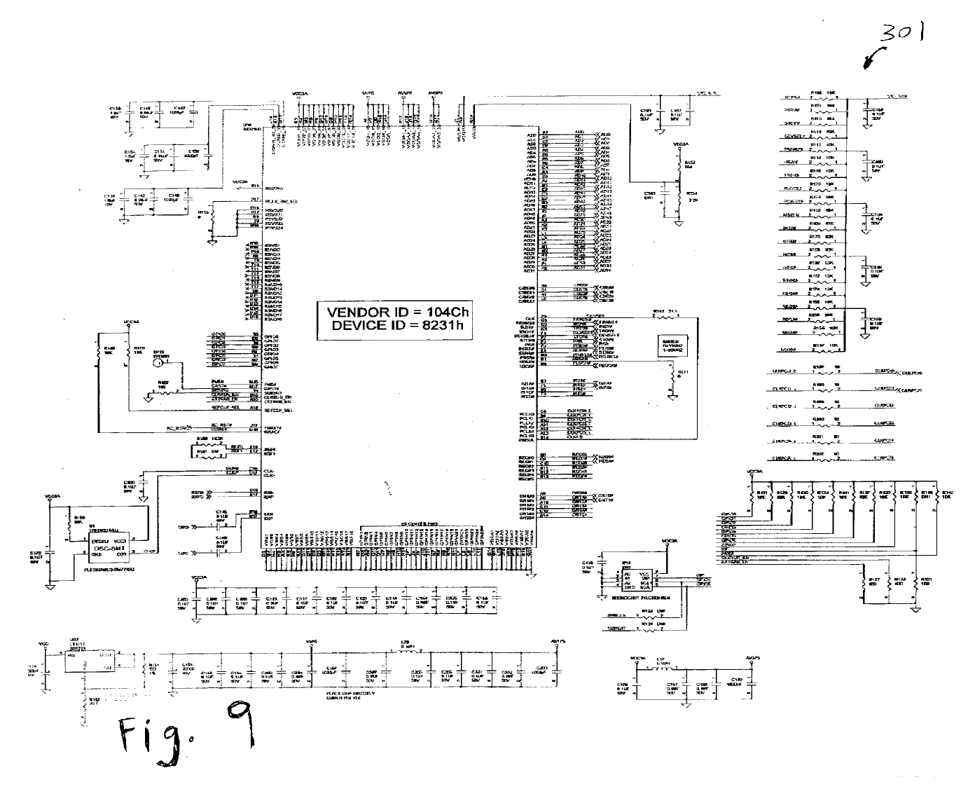

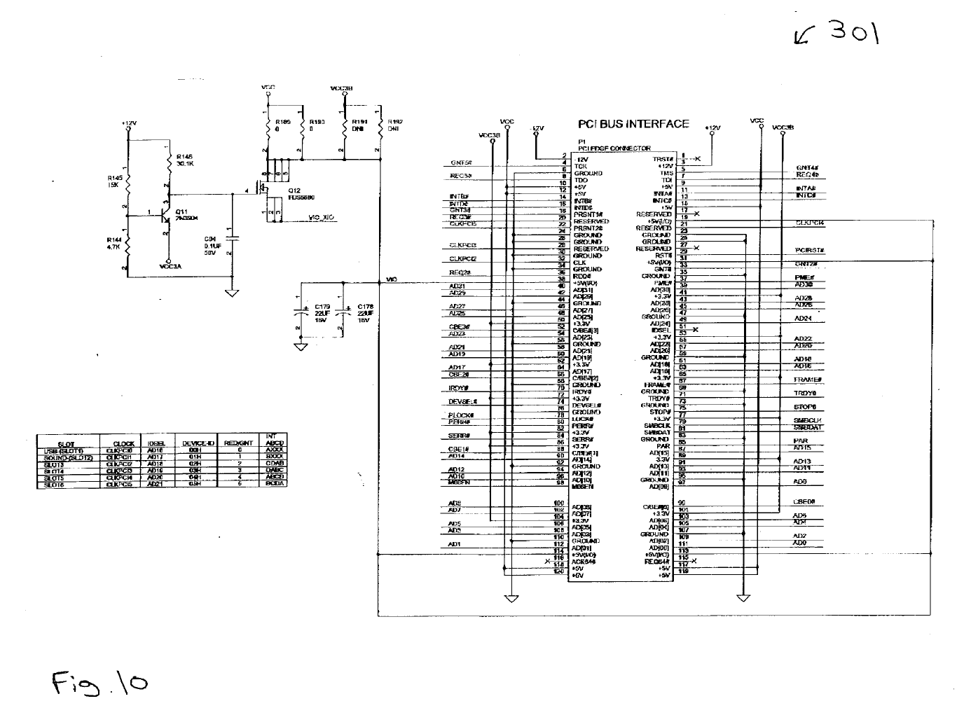

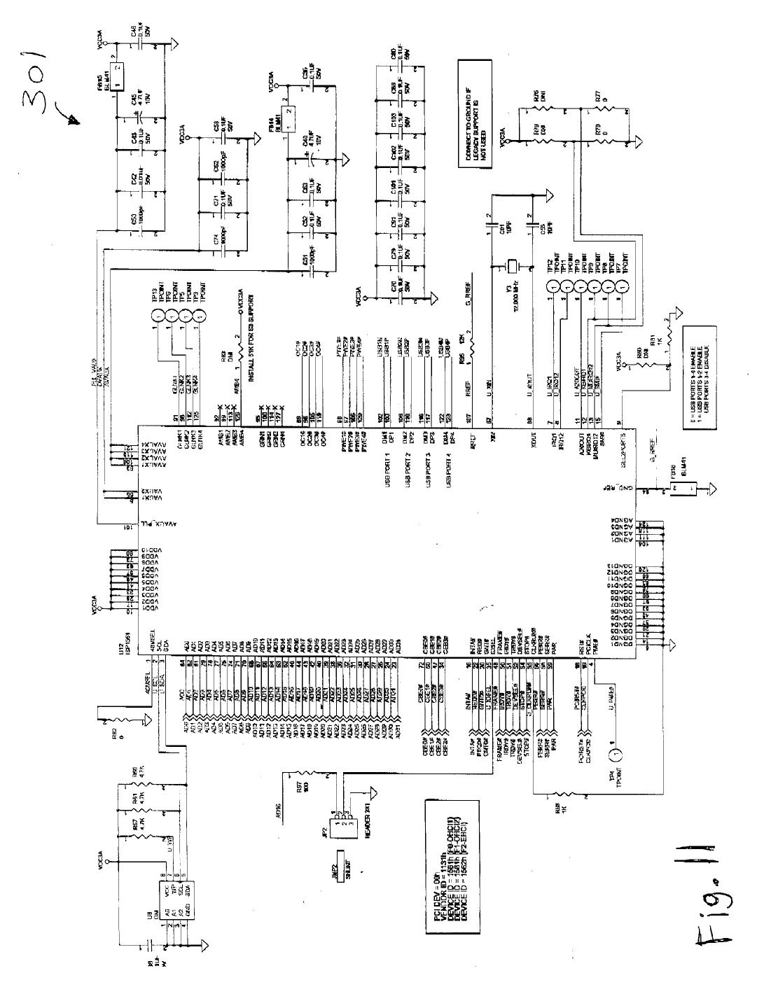

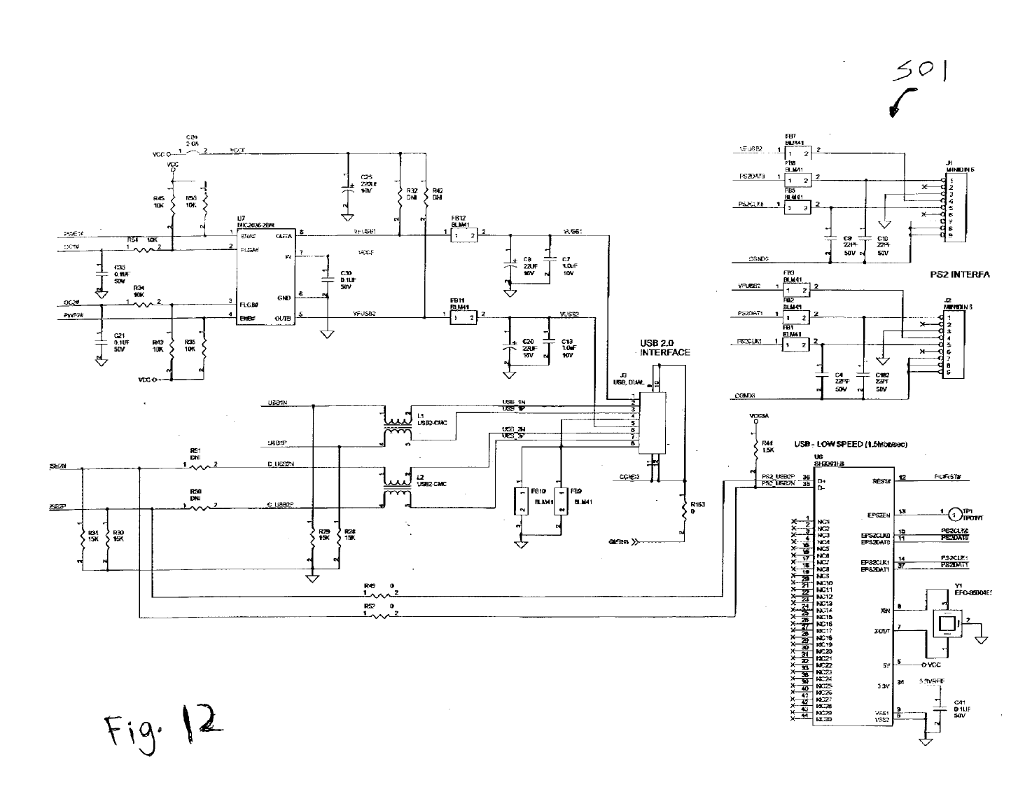

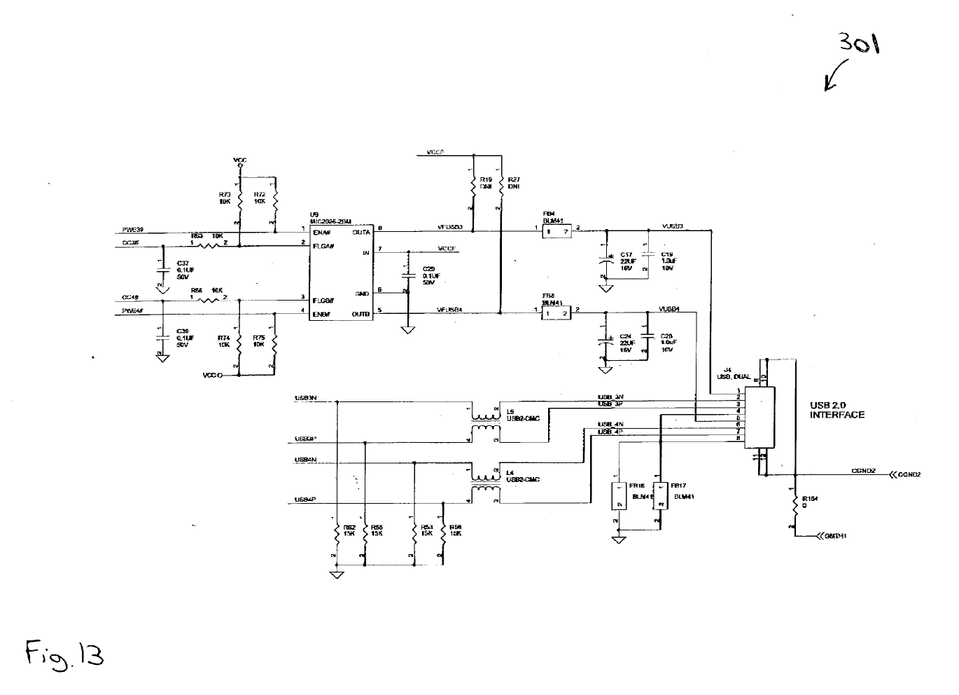

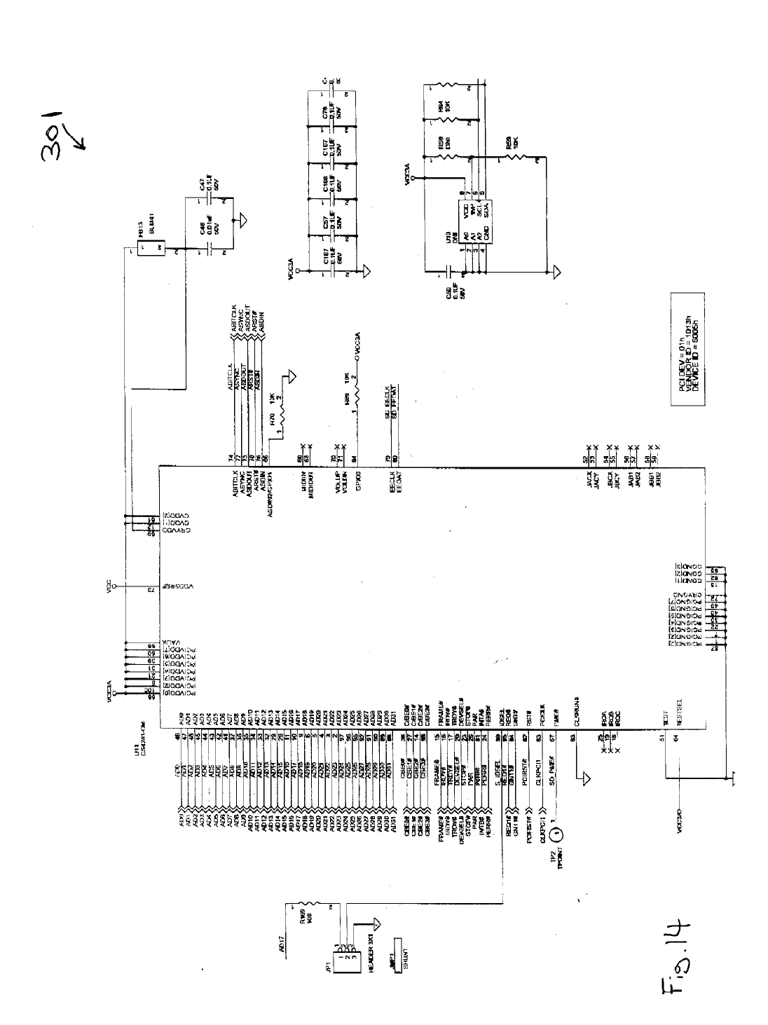

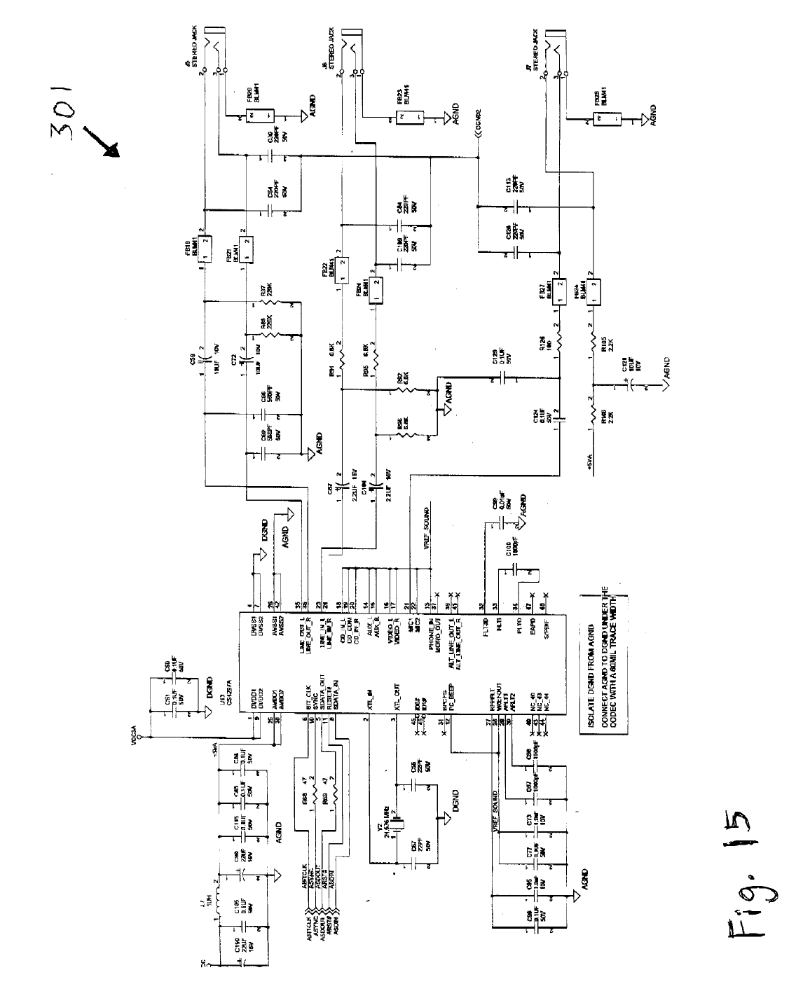

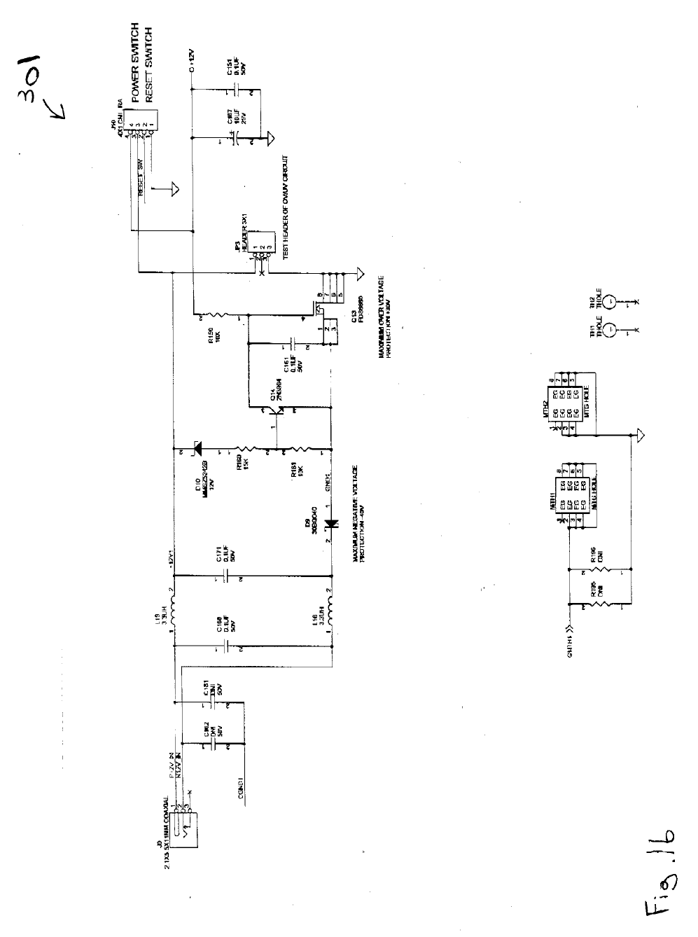

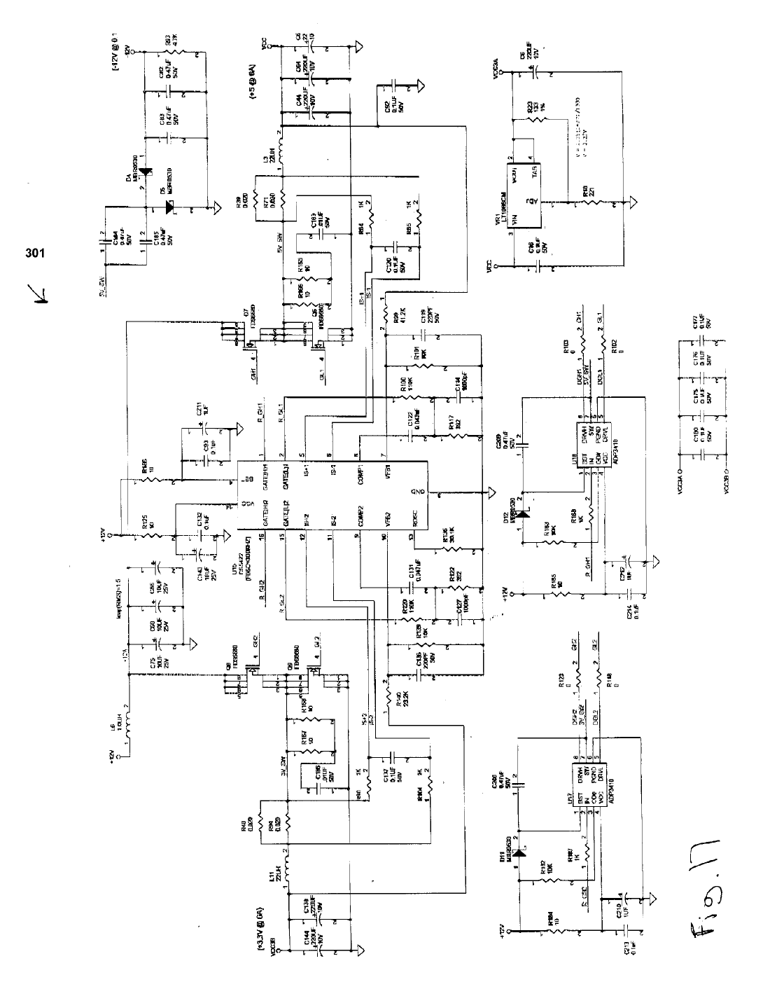

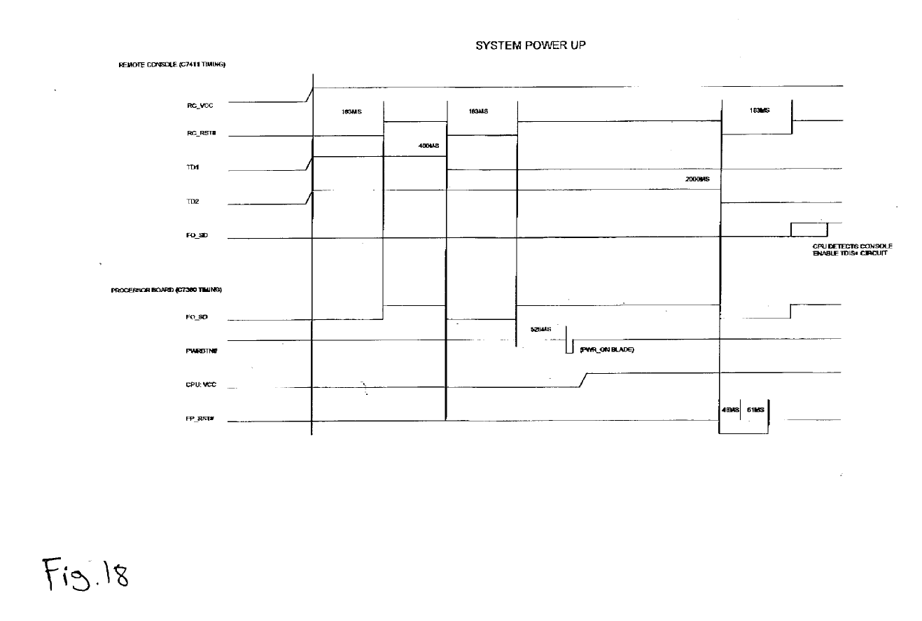

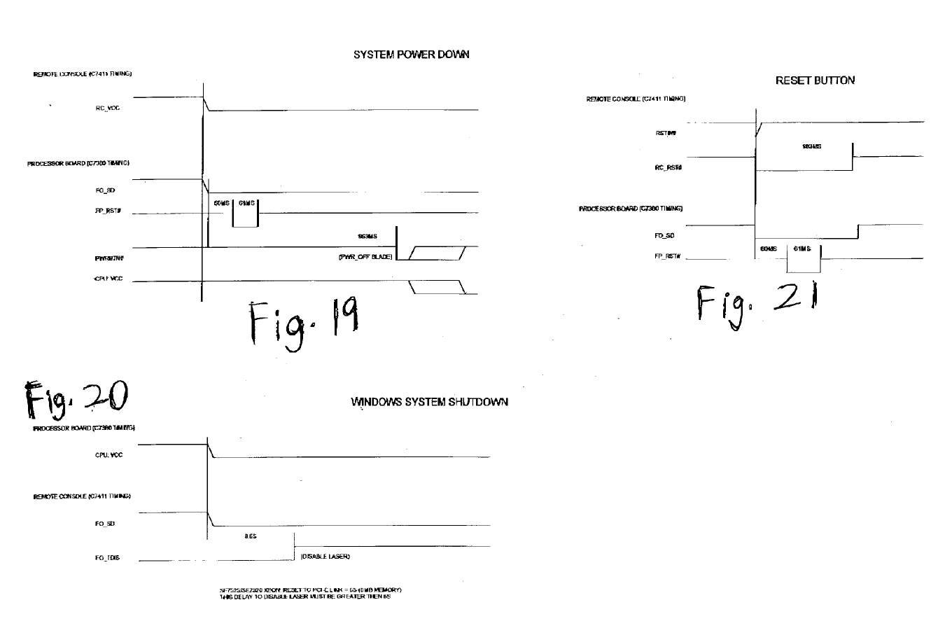

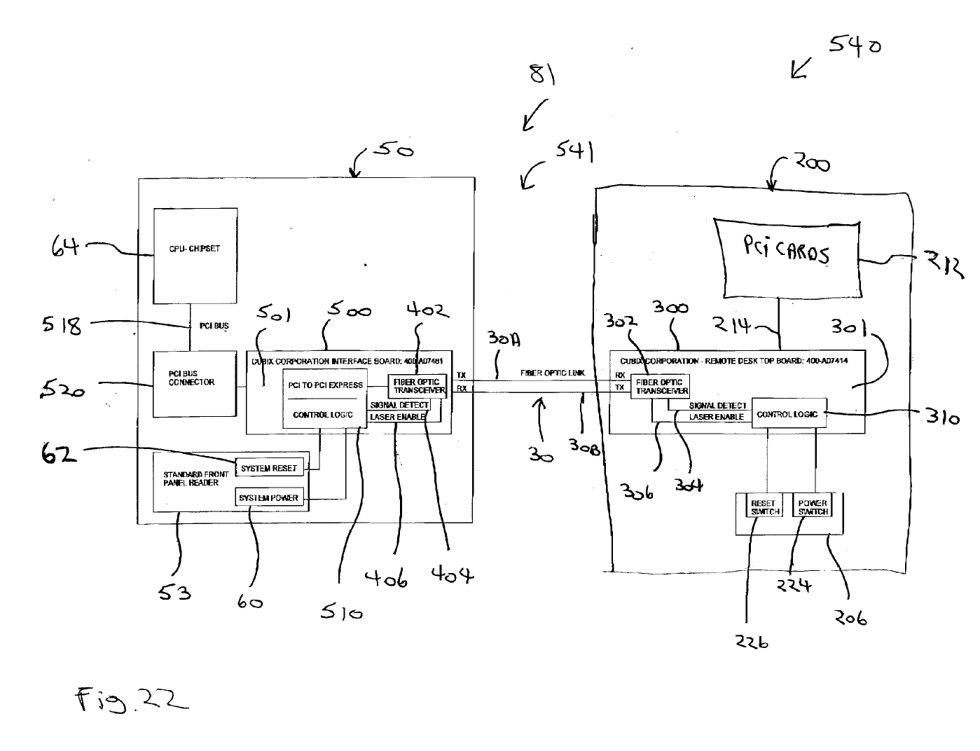

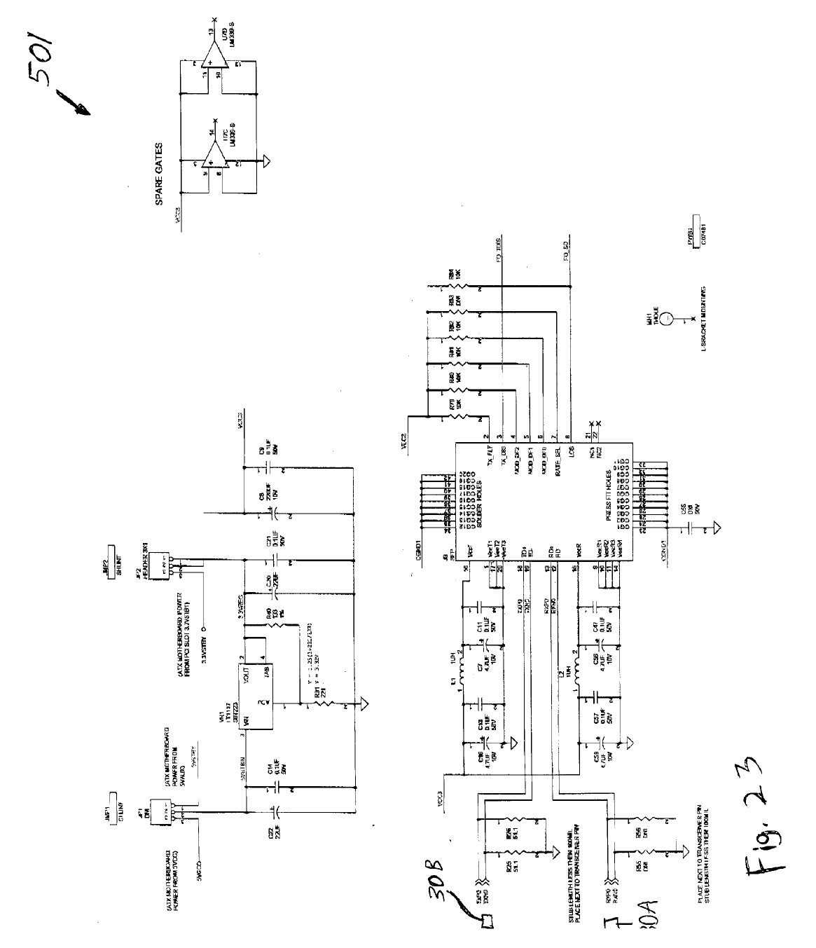

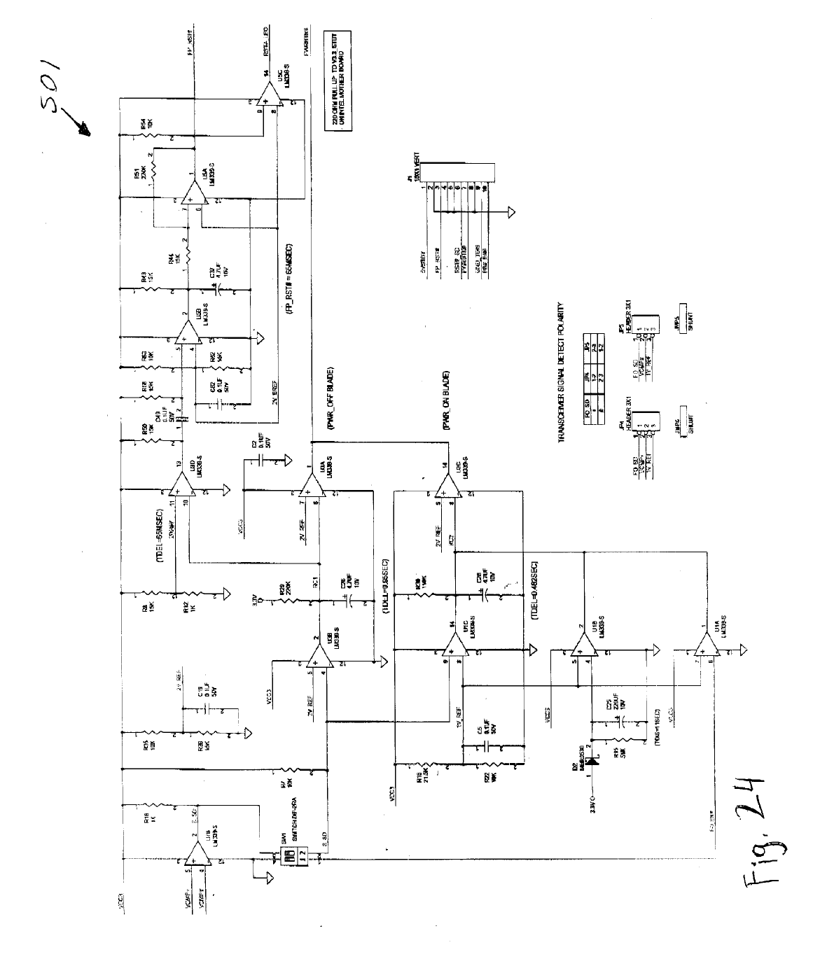

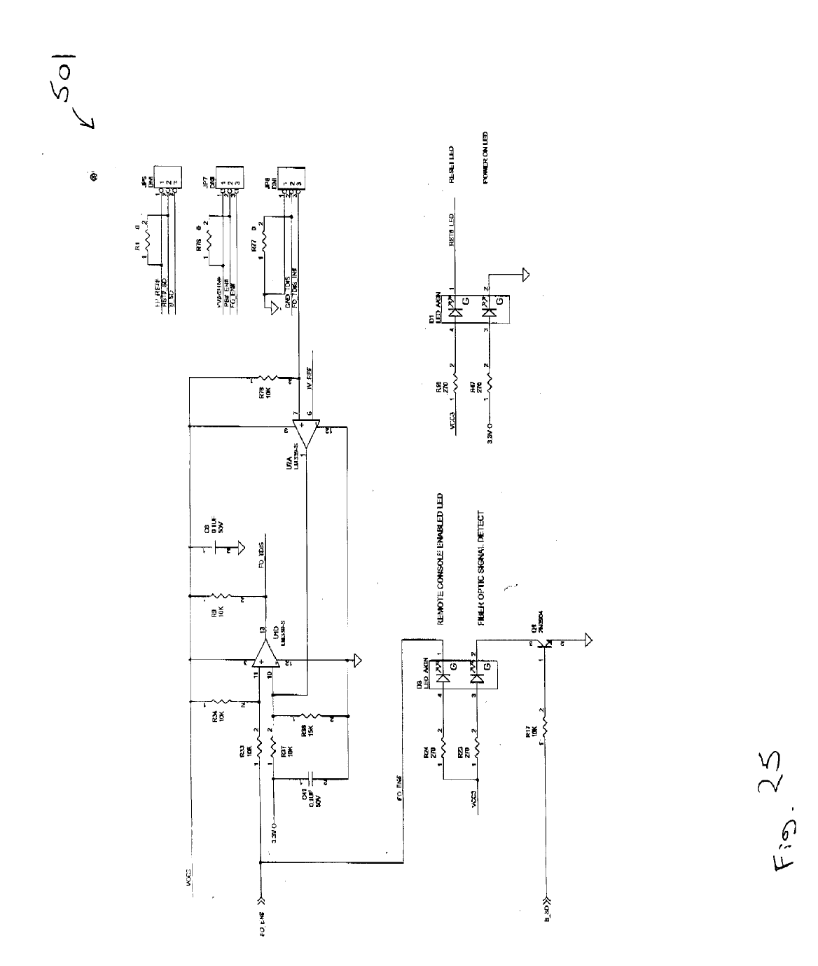

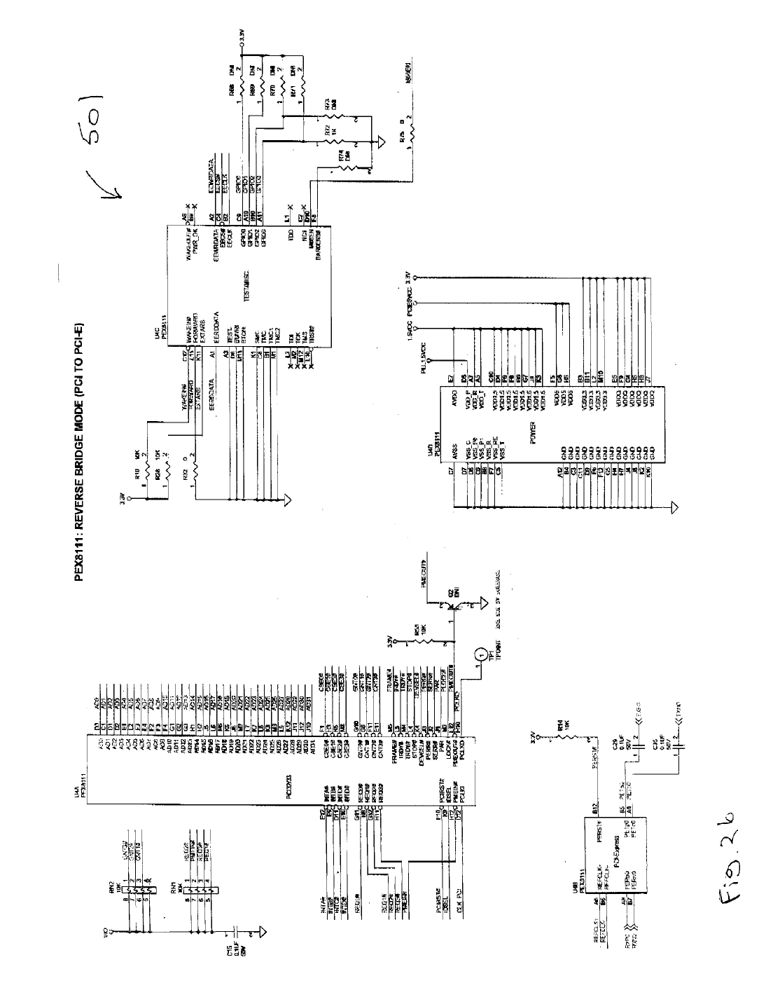

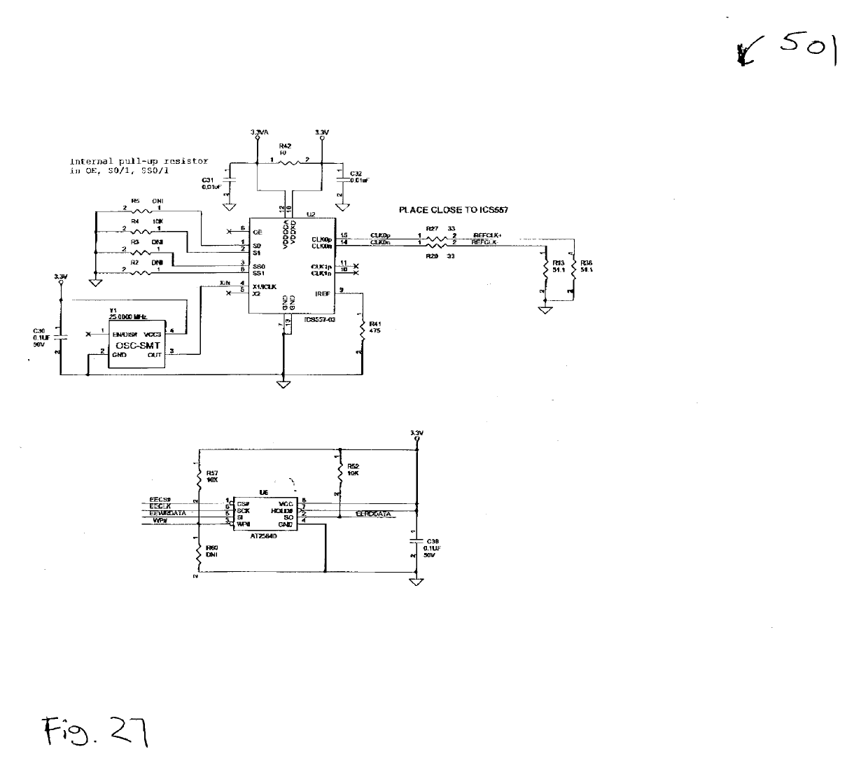

Referring to FIG. 2, a physical layout of communication device 21 is shown. Host computer 50 can have a housing 52 that has a cavity 51 and a front panel 53. A portion of front panel 53 is removed to view into cavity 51. A power connector 54 is mounted to front panel 53 and can be connected to a source of electrical power. A network cable 56 can be connected to host computer 50 through a connector 57. Network cable 56 can connect host computer 50 to other computers or to other networks such as the internet.

Motherboard 70 can be mounted in cavity 51. Motherboard 70 can be a conventional personal computer motherboard and can have electronic connectors 72. A computer interface card 400 is mounted to connector 72. A fiber optic connector 58 may be mounted to computer interface card 400 and can be connected to fiber optic cable end 32. An on/off switch 60 and system-reset switch 62 can be mounted to front panel 53.

Host computer 50 is connected to remote interface box 200 through fiber optic cable 30. Remote interface box 200 is located at a remote location 201. Remote interface box 200 can include a housing 202 that has an internal cavity 204 and a front panel 206. A portion of front panel 206 is removed to view into cavity 204. Housing 202 can be fabricated from metal or plastic. A printed circuit motherboard 208 may be mounted in cavity 204.

Several card connectors 210 are fastened to motherboard 208. Connectors 210 are conventional electronic circuit card connectors. Various printed circuit boards can be plugged into connectors 210. For example, PCI adapter cards 212 and remote interface circuit card 300 are shown engaged with connectors 210 in FIG. 2. PCI adapter cards 212 can interface a wide variety of peripheral devices 100 to motherboard 208. For example, PCI adapter cards 212 can be video graphics cards that can connect with a monitor or can be a sound card.

A fiber optic connector 220 may be mounted to front panel 206 and can be connected to fiber optic cable end 34. Fiber optic connector 220 is mounted adjacent to remote interface circuit card 300. An on/off switch 224 and system-reset switch 226 can be mounted to front panel 206. Several conventional USB connectors 222 are located on front panel 206 and are used to connect a USB device with motherboard 208.

Turning now to FIG. 3, a more detailed view of communication device 21 is shown. In FIG. 3, a split computer bus 80 is shown. A portion of the bus resides within host computer 50 and a portion resides within remote interface box 200. Host computer 50 can include a central processing unit (CPU) 64 that is in communication with a PCI express bus 66. Central processing unit 64 can be a conventional microprocessor. PCI express bus 66 is connected with a PCI express bus connector 68. Computer interface card 400 is electrically connected with connector 68. CPU 64 can send a high speed serial PCI electrical data or address signal on PCI express bus 66.

Computer interface card 400 contains a computer interface circuit 401. Computer interface circuit 401 can receive the serial PCI express bus electrical signal, convert the electrical signal to an optical signal and transmit the optical signal on fiber optic cable 30. Similarly, computer interface circuit 401 can also reverse this process and convert the optical signal to a PCI express bus electrical data signal.

Computer interface circuit 401 includes a fiber optic transceiver 402 and control logic 410. Fiber optic transceiver 402 is commercially available from Lucent Corporation. Control logic 410 can be connected with switches 60 and 62. A signal detect line 404 is connected between control logic 410 and transceiver 402. A laser enable line 406 is connected between control logic 410 and transceiver 402. Transceiver 402 is connected with fiber optic transmission cable 30A and receiver cable 30B.

Remote interface box 200 can include a remote interface card 300 that is in communication with a PCI bus 214. PCI bus 214 is connected to PCI adapter cards 212. PCI bus 214 is a parallel bus that can carry electrical data and address signals between card 300 and cards 212.

Remote interface card 300 contains a remote interface circuit 301. Remote interface circuit 301 can receive the optical signal from fiber optic cable 30, convert the optical signal to a parallel electrical data signal and transmit the electrical data signal on PCI bus 214. Similarly, remote interface circuit 301 can also reverse this process and convert the PCI bus electrical data signal to an optical signal.

Remote interface circuit 301 includes a fiber optic transceiver 302 and control logic 310. Fiber optic transceiver 302 is commercially available from Lucent Corporation. Control logic 310 can be connected with switches 226 and 224. A signal detect line 304 is connected between control logic 310 and transceiver 302. A laser enable line 306 is connected between control logic 310 and transceiver 302. Transceiver 302 is connected with fiber optic transmission cable 30A and receiver cable 30B.

FIG. 3 shows the split computer bus 80 having two portions, the PCI express bus 66 that resides with the host computer 50 and CPU 64 and the PCI bus 214 that resides with the remote interface box 200 that can be connected to various peripheral devices. PCI express bus 66 is in electrical communication with PCI bus 214 through fiber optic cable 30. The split computer bus 80 allows the host computer 50 to be widely separated from any peripheral devices.

Referring now to FIGS. 4-6, detailed electrical schematic views of an embodiment of computer interface circuit 401 are shown. Circuit 401 is a PCI express bus to fiber optic conversion circuit. It is understood that other electronic components and architectures can also be used to form other embodiments of computer interface circuit 401.

Referring now to FIGS. 7-17, detailed electrical schematic views of an embodiment of remote interface circuit 301 are shown. Circuit 301 is a fiber optic to PCI bus conversion circuit. It is understood that other electronic components and architectures can also be used to form other embodiments of computer interface circuit 301.

Timing Diagrams

With reference to FIG. 18, a timing diagram of computer system 20 during power up is shown. Power is first applied to the remote interface box. After TD1 time out, the remote PCI bus is reset. This causes the remote interface circuit to attempt to establish a link. The control logic at the processor motherboard detects the fiber optic signal. The power button signal on the front panel is pulsed turning on power. After TD2 time out the remote interface circuit is again reset. This causes a loss of the fiber optic signal at the processor motherboard. The control logic then pulses reset on the front panel. Reset timing is now established so that the remote interface circuit comes out of reset after the processor mother board resets. At this point both the processor motherboard and the remote interface circuit begin link protocol arbitration. After this successfully takes places, the link is established.

Turning to FIG. 19, a timing diagram of computer system 20 during power down is shown. Power is first removed from the remote interface circuit. The fiber optic link to the processor motherboard is removed. The control logic detects loss of the fiber optic link. The processor motherboard reset to the front panel is pulsed. After an established time out, if the fiber optic signal does not return then the power button signal on the front panel is pulled low. This causes the processor motherboard to power off and return to sleep state and the fiber optic transceiver lasers are latched off.

Referring to FIG. 20, a timing diagram of computer system 20 during shutdown is shown. The operating system shuts down and the processor returns to a sleep mode state. The fiber optic link to the remote interface circuit is removed. The fiber optic transceiver lasers are latched off. Power cycle of the remote interface circuit is required to re-enable the laser and begin the system power up sequencing.

Referring to FIG. 21, a timing diagram of computer system 20 during reset is shown.

The reset button on the remote PCI device is pressed. The remote PCI controller is reset. The fiber optic link to the processor motherboard is removed. The control logic detects loss of the fiber optic link. The processor motherboard resets when the front panel logic is pulsed. Reset timing is such that the remote interface circuit comes out of reset after the processor motherboard resets. At this point both the processor motherboard and the remote interface circuit reset and new link arbitration begins to re-establish the link.

Alternative Embodiment

FIG. 22 is substantially a diagrammatic view of another embodiment of a computer system 540 and communication device 541 in accordance with the present invention. FIG. 22 is similar to FIG. 3, except that computer interface circuit 401 has been replaced by computer interface circuit 501. A further change is that the PCI express bus 66 has been replaced by PCI bus 518.

Computer interface card 500 contains a computer interface circuit 501. Computer interface circuit 501 can receive the parallel PCI bus electrical signal, convert the electrical signal to an optical signal and transmit the optical signal on fiber optic cable 30. Similarly, computer interface circuit 501 can also reverse this process and convert the optical signal to a PCI bus electrical data signal.

Computer interface circuit 501 includes a fiber optic transceiver 402 and control logic 510. Fiber optic transceiver 402 is commercially available from Lucent Corporation. Control logic 510 can be connected with switches 60 and 62. A signal detect line 404 is connected between control logic 510 and transceiver 402. A laser enable line 406 is connected between control logic 510 and transceiver 402. Transceiver 402 is connected with fiber optic transmission cable 30A and receiver cable 30B.

Computer system 540 would operate the same as previously described for computer system 20. Computer system 540 allows a host computer with a PCI bus to communicate through an optical fiber with remote peripheral devices and to have a split computer bus 81.

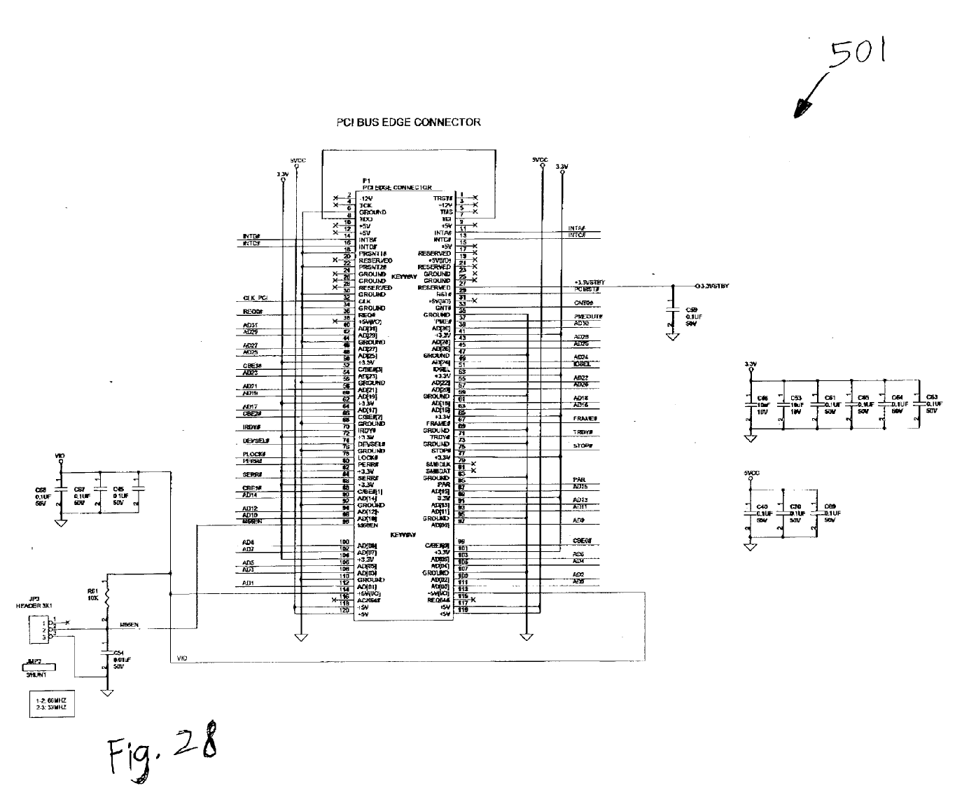

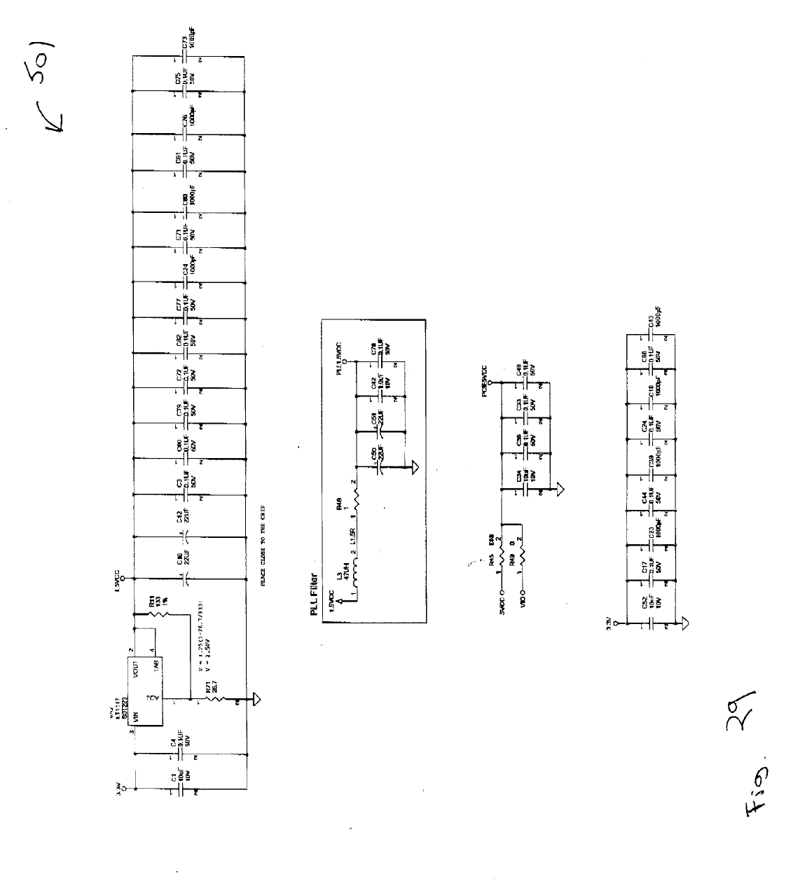

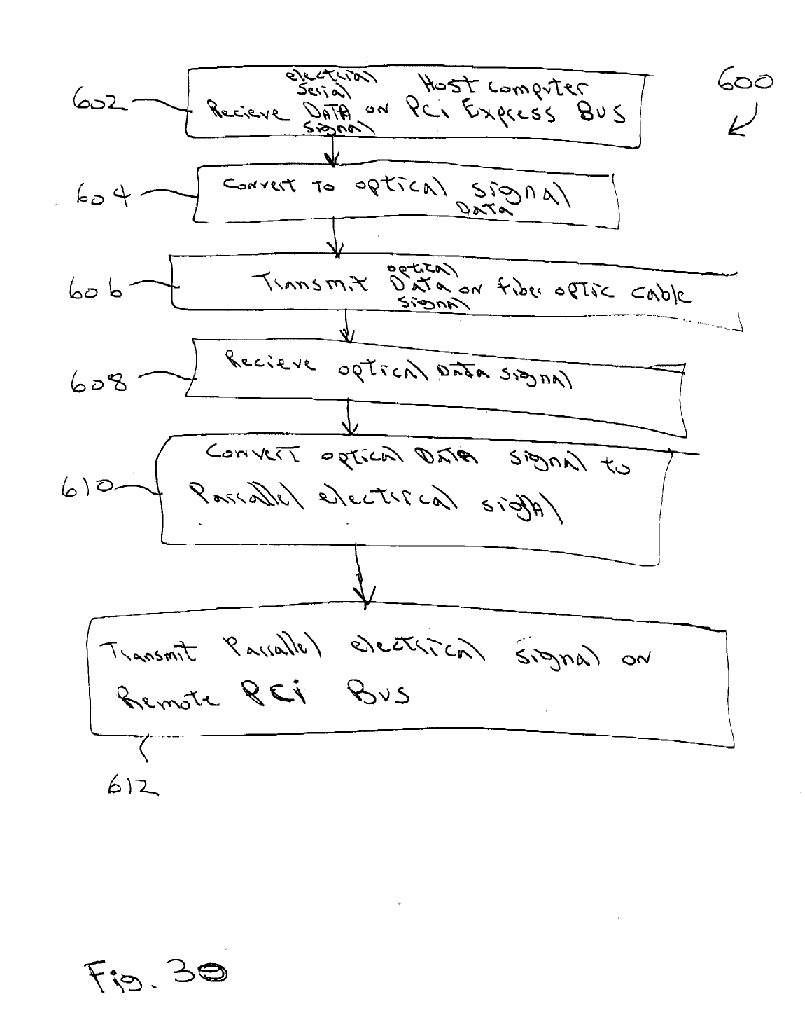

Turning to FIGS. 23-29, detailed electrical schematic views of an embodiment of computer interface circuit 501 are shown. Circuit 501 is a PCI bus to fiber optic conversion circuit. It is understood that other electronic components and architectures can also be used to form other embodiments of computer interface circuit 501.

Operation

Referring to FIG. 3, during operation of computer system 20 and after system power up sequencing is completed. The computer interface circuit 401 receives electrical data in the form of electrical signals from PCI express bus 66. Computer interface circuit 401 converts the electrical signals into optical signals using fiber optic transceiver 402. The optical signals are transmitted along fiber optic cable 30 to fiber optic transceiver 302. Computer interface circuit 301 converts the optical signals into electrical signals and places these onto to the remote PCI bus 214. The interface cards assure that correct timing is maintained during transmission of the fiber optic cable and on the PCI busses.

Computer system 20 operates in a similar but opposite manner when transmitting data from a peripheral device back to the host computer. The remote interface circuit 301 receives electrical data in the form of electrical signals from PCI bus 214. Remote interface circuit 301 converts the electrical signals into optical signals using fiber optic transceiver 302. The optical signals are transmitted along fiber optic cable 30 to fiber optic transceiver 402. Computer interface circuit 401 converts the optical signals into electrical signals and places these onto to the PCI express bus 66. The interface cards assure that correct timing is maintained during transmission of the fiber optic cable and on the PCI busses.

The remote PCI bus 214 at the remote location functions identical to PCI bus 66 that is resident on the processor motherboard 70. This allows standard PCI adapter cards 212 to be plugged into remote motherboard 208 that is hundreds of meters distant from the central processor unit 64 and disk drive storage devices.

Method of Use

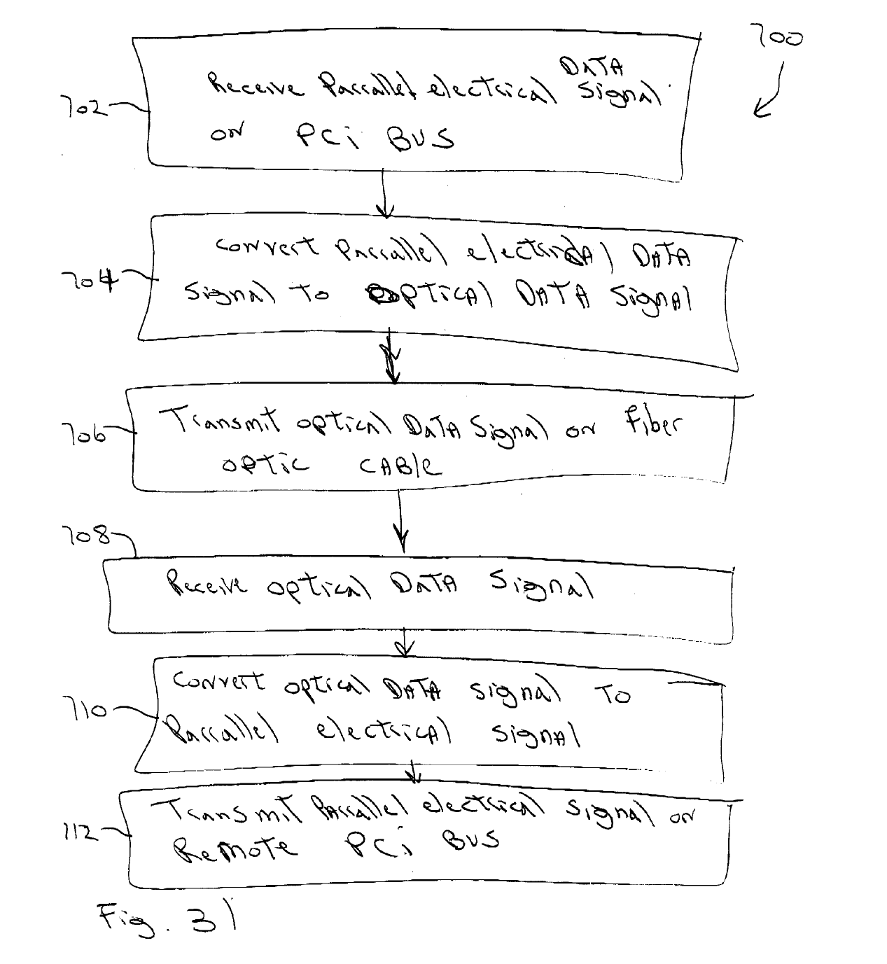

With reference to FIG. 30, a method of communicating data is shown. Method 600 includes receiving a serial electrical data signal from a host computer PCI express bus into a computer interface circuit at step 602. At step 604, the electrical data signal is converted to an optical signal. The optical signal is transmitted over the fiber optic cable at step 606. At step 608, the optical signal is received by the remote interface circuit. The optical signal is converted to a parallel electrical data signal at step 610. At step 612 the parallel electrical data signal is placed onto the remote PCI bus.

The order of steps 602 to 612 can be reversed in order to transmit data from the remote PCI bus to the host PCI express bus.

Referring to FIG. 31, another method of communicating data is shown. Method 700 includes receiving a parallel electrical data signal from a host computer PCI bus into a computer interface circuit at step 702. At step 704, the electrical data signal is converted to an optical signal. The optical signal is transmitted over the fiber optic cable at step 706. At step 708, the optical signal is received by the remote interface circuit. The optical signal is converted to a parallel electrical data signal at step 710. At step 712 the parallel electrical data signal is placed onto the remote PCI bus.

The order of steps 702 to 712 can be reversed in order to transmit data from the remote PCI bus to the host PCI bus.

### CONCLUSION

It can thus be realized that the certain embodiments of the present invention can provide a secure computer system that has peripheral devices located remotely from the computer processor and storage devices. The present invention provides a split computer bus using optical communication that improves data security and is impervious to electronic eavesdropping.

Although the description above contains many specifications, these should not be construed as limiting the scope of the invention but as providing illustrations of some of present embodiments of this invention. Thus, the scope of the invention should be determined by the appended claims and their legal equivalents rather than by the examples given.

What is claimed is:

1. A computer communication device comprising:
a first interface circuit mounted in association with a computer, the first interface circuit connected between a computer bus and a first fiber optic transceiver, the first fiber optic transceiver being adapted to be connected with a first end of a fiber optic cable;
a second interface circuit mounted remotely from the computer, the second interface circuit connected between a peripheral device bus and a second fiber optic transceiver, the second fiber optic transceiver being adapted to be connected with a second end of the fiber optic cable, the computer communication device allowing a peripheral device to be located remote from the computer.

2. The communication device of claim 1, wherein the computer bus is a serial bus.

3. The communication device of claim 1, wherein the computer bus is a PCI express bus.

4. The communication device of claim 1, wherein the peripheral device bus is a parallel bus.

5. The communication device of claim 1, wherein the peripheral device bus is a PCI bus.

6. The communication device of claim 1, wherein the second interface circuit can be connected with a plurality of peripheral devices.

7. The communication device of claim 1, wherein the second interface circuit is mounted in a housing, the housing having a plurality of circuit card slots.

8. A computer network comprising:
a) a host computer having a serial bus;
b) a first interface circuit mounted with the host computer and in communication with the serial bus;
c) a first fiber optic transceiver connected to the first interface circuit;
d) a fiber optic cable having a first end and a second end, the first end of the fiber optic cable connected to the first fiber optic transceiver;
e) a second interface circuit mounted remotely from the host computer, the second interface circuit in communication with a parallel peripheral device bus, the parallel peripheral device bus being adapted to be connected with a plurality of peripheral devices; and
f) a second fiber optic transceiver connected to the second interface circuit, the second fiber optic transceiver further connected to the second end of the fiber optic cable, the computer network allowing communication between the peripheral devices and the host computer.

9. The computer network of claim 8, wherein at least one peripheral device is a monitor.

10. The computer network of claim 8 wherein at least one peripheral device is a keyboard.

11. The computer network of claim 8, wherein a data storage device is mounted with the host computer.

12. The computer network of claim 8, wherein the host computer is mounted in a secure location remote from the peripheral devices.

13. A computer communication device comprising:
a) a processor;
b) a first interface circuit in communication with the processor;
c) a second interface circuit in communication with a peripheral device, the peripheral device being mounted remotely from the processor;
d) software operative on the processor and the communication device to:
1) receive a first electrical signal on the first interface circuit from the processor;
2) convert the first electrical signal to an optical signal;
3) transmit the optical signal from the first interface circuit to the second interface circuit;
4) receive the optical signal on the second interface circuit;
5) convert the optical signal to a second electrical signal; and
6) transmit the second electrical signal to the peripheral device.

14. The communication device of claim 13, wherein the optical signal is transmitted over a fiber optic cable.

15. The communication device of claim 13, wherein a fiber optic transceiver coverts the first electrical signal to the optical signal.

16. The communication device of claim 13, wherein the first electrical signal is a serial signal.

17. The communication device of claim 13, wherein the second electrical signal is a parallel signal.

18. The communication device of claim 13, wherein the second interface circuit can be connected with a plurality of peripheral devices.

19. A method of communicating between a peripheral device and a computer, but not necessarily in the order shown, comprising:
a) transmitting a first electrical signal from the computer to a first interface circuit;
b) converting the first electrical signal to an optical signal;
c) transmitting the optical signal from the first interface circuit to a second interface circuit;
d) converting the optical signal to a second electrical signal; and
e) transmitting the second electrical signal to the peripheral device.

20. The method of claim 19, wherein the first electrical signal is a serial electrical signal.

21. The method of claim 19, wherein the second electrical signal is a parallel electrical signal.

22. The method of claim 21, wherein the parallel electrical signal is transmitted to a plurality of peripheral devices.
